(19) United States
(12) Patent Application Publication
(10) Pub. No.: US 2024/0237071 A1
(43) Pub. Date: Jul. 11, 2024

(54) WIRELESS COMMUNICATION METHOD AND WIRELESS STATION

(71) Applicant: GUANGDONG OPPO MOBILE TELECOMMUNICATIONS CORP., LTD., Dongguan (CN)

(72) Inventors: Liuming LU, Dongguan (CN); Yanchao XU, Dongguan (CN); Lei HUANG, Singapore (SG)

(73) Assignee: GUANGDONG OPPO MOBILE TELECOMMUNICATIONS CORP., LTD., Dongguan (CN)

(21) Appl. No.: 18/615,748

(22) Filed: Mar. 25, 2024

Related U.S. Application Data
(63) Continuation of application No. PCT/CN2021/121107, filed on Sep. 27, 2021.

(51) Int. Cl. H04W 74/0816; H04W 74/08; H04W 76/19

(52) U.S. Cl. CPC H04W 74/0816; H04W 74/0891; H04W 76/19

(57) ABSTRACT

A wireless communication method for medium access recovery executed by a wireless station (STA) is provided. During medium access recovery, the method uses enhanced rules to reset or not reset a medium synchronization delay timer, such as MediumSyncDelay timer, for various situations associated with a simultaneous transmit and receive (STR) or non-STR (NSTR) multi-link device (MLD), or a tunneled direct-link setup (TDLS) peer STA. The method uses a medium access recovery subfield to indicate whether a multiple user request to send (MU-RTS) trigger frame is sent by an STA that has a nonzero MediumSyncDelay timer.

### CROSS REFERENCE TO RELATED APPLICATIONS

The present disclosure is a continuation of International Patent Application No. PCT/CN2021/121107, filed Sep. 27, 2021, the contents of which is herein incorporated by reference in its entirety.

### TECHNICAL FIELD

The present disclosure relates to the field of communication systems, and more particularly, to a wireless communication method and a wireless station medium access recovery.

### BACKGROUND ART

Communication systems such as wireless communication systems are widely deployed to provide various types of communication content such as voice, video, packet data, messaging, broadcast, and so on. These communication systems may be multiple-access systems capable of supporting communication with multiple users by sharing available system resources (such as time, frequency, and power). A wireless network, for example, a wireless local area network (WLAN), such as a WI-FI (institute of electrical and electronics engineers (IEEE) 802.11) network may include an access point (AP) that may communicate with one or more wireless mobile stations (STAs) or devices. The WLAN enables a user to wirelessly access internet based on radio frequency technology in a home, an office, or a specific service area using a portable terminal such as a personal digital assistant (PDA), a laptop computer, a portable multimedia player (PMP), a smartphone, etc. The AP may be coupled to a network, such as the internet, and may enable a mobile device to communicate via the network (or communicate with other devices coupled to the AP). A wireless device may communicate with a network device bi-directionally. For example, in a WLAN, an STA may communicate with an associated AP via downlink and uplink. The downlink may refer to a communication link from the AP to the STA, and the uplink may refer to a communication link from the STA to the AP.

### Technical Problem

IEEE 802.11be WG has introduced a multi-link device (MLD) in a WLAN extreme high throughput (EHT) features and defined a multi-link (ML) discovery procedure for an STA affiliated with a non-AP MLD to solicit ML capabilities of APs affiliated with an AP MLD. An MLD is an IEEE 802.11 capable device and a logical entity, and has two or more affiliated stations (STAs), such as two or more non-AP STAs or APs, and a single medium access control (MAC) service access point (SAP) to logical link control (LLC), which includes one MAC data service.

IEEE 802.11be draft 1.1 has specified a medium access recovery procedure to address the blindness issue at a non-AP multi-link device (MLD) with a non-simultaneous transmit and receive (NSTR) pair.

The relevant rules of the medium access recovery procedure or mechanism comprise:
1) An STA that has lost medium synchronization due to transmission by another STA affiliated with the same MLD shall start a MediumSyncDelay timer at the end of that transmission event if that transmission event is longer than aMediumSyncThreshold.
2) the medium synchronization delay timer resets to zero when any of the following events occur:
   The STA receives a PPDU with a valid medium access control (MAC) protocol data unit (MPDU); and/or
   The STA receives a PPDU whose corresponding RXVECTOR parameter TXOP_DURATION is not UNSPECIFIED.
3) A non-AP STA is affiliated with non-AP MLD, has a nonzero MediumSyncDelay timer, and supports to obtain a TXOP, and the non-AP STA shall:
   transmit an RTS frame as the first frame of any attempt to obtain a TXOP.
   not attempt to initiate more than MSD_TXOP_MAX TXOPs.
   use CCA_ED threshold that is equal to dot11MSDOFDMEDthreshold.

The problems in the current medium access recovery mechanism comprise:
Multiple STAs affiliated with different MLDs can have their respective nonzero MediumSyncDelay timers (MSD timer). For example, when an AP can solicit trigger-based (TB) physical layer (PHY) protocol data units (PPDUs) from multiple MLDs operating on an NSTR link pair, the solicited STAs sets their MediumSyncDelay timers. In this case, if one of the multiple STAs transmits a request to send (RTS) frame as the first frame, all other STAs can reset timer mistakenly based on the RTS frame, even though there is no response to the RTS frame.

For example, with reference to FIG. 1, an STA 121c and an STA 122c affiliated with a non-AP MLD 120c operate on an NSTR pair, and an STA 123c and an STA 124c affiliated with a non-AP MLD 120d operate on another NSTR pair. An AP 111c and an AP 112c are affiliated with an AP MLD 110c. When the AP 112c transmits a trigger frame to solicit TB PPDUs from the STA 122c affiliated with MLD 120c and the STA 123c affiliated with MLD 120d, the STA 121c and the STA 124c start their MediumSyncDelay timers respectively. According to the currently specified rules when the STA 121c transmits an RTS frame 40a as the first frame of any attempt to obtain a TXOP, the STA 124c resets its MediumSyncDelay timer mistakenly on time TI based on the RTS frame, even though there is no response to the RTS frame detected.

Hence, it is desirable to provide a wireless communication method and a wireless device to address the problems in the current standards.

### Technical Solution

An object of the present disclosure is to propose a wireless communication method and a wireless station.

A first aspect of the disclosure provides a wireless communication method including: a wireless station (STA) affiliated with a multi-link device (MLD), which has a nonzero medium synchronization delay (i.e. MediumSyncDelay) timer, when receiving a physical protocol data unit (PPDU) with a valid media access control PDU (MPDU) that contains a request to send (RTS) frame or a multi-user RTS (MU-RTS) trigger frame, determining whether to reset the medium synchronization delay timer to zero according to detecting of the PPDU; or a STA, that supports an operation for a control frame including a medium access recovery subfield, transmitting a control frame including a medium access recovery subfield indicating whether the control frame is sent by the STA that has a nonzero MediumSyncDelay timer if needed.

A second aspect of the disclosure provides a STA. The STA includes a processor, and the processor is configured to call and run a computer program stored in a memory, to cause a device in which a chip is installed to execute a method. The method includes: the STA affiliated with an MLD, which has a nonzero MediumSyncDelay timer, when receiving a PPDU with a valid MPDU that contains a RTS frame or an MU-RTS trigger frame, determining whether to reset the MediumSyncDelay timer to zero according to detecting of the PPDU. Alternatively, the method includes: the STA, that supports an operation for a control frame including a medium access recovery subfield, transmitting a control frame including a medium access recovery subfield indicating whether the control frame is sent by the STA that has a nonzero MediumSyncDelay timer if needed.

A third aspect of the disclosure provides a computer readable storage medium, in which a computer program is stored. The computer program causes a computer to execute a method, and the method includes: a STA affiliated with an MLD, which has a nonzero MediumSyncDelay timer, when receiving a PPDU with a valid MPDU that contains a RTS frame or an MU-RTS trigger frame, determining whether to reset the MediumSyncDelay timer to zero according to detecting of the PPDU. Alternatively, the method includes: a STA, that supports an operation for a control frame including a medium access recovery subfield, transmitting a control frame including a medium access recovery subfield indicating whether the control frame is sent by the STA that has a nonzero MediumSyncDelay timer if needed.

### DESCRIPTION OF THE DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating a problem of current medium access recovery mechanism.

FIG. 2 is a schematic diagram illustrating an example of a wireless communications system according to an embodiment of the present disclosure.

FIG. 3 is a schematic diagram illustrating one or more stations (STAs) and an access point (AP) of communication in a wireless communications system according to an embodiment of the present disclosure.

FIG. 4 is a schematic diagram showing an AP STA affiliated with an NSTR soft AP MLD.

FIG. 5 is a schematic diagram showing a wireless communication method during transmission according to an embodiment of the invention.

FIG. 6 is a schematic diagram showing a wireless communication method during detection according to an embodiment of the invention.

FIG. 7 is a schematic diagram showing a first example of a EHT variant Common Info field format of a trigger frame.

FIG. 8 is a schematic diagram showing a second example of a EHT variant Common Info field format of a trigger frame.

FIG. 9 is a schematic diagram showing a third example of a EHT variant Common Info field format of a trigger frame.

FIG. 10 is a schematic diagram showing an embodiment of the wireless communication method using an enhanced rule for detection of RTS frames.

FIG. 11 is a schematic diagram showing another embodiment of the wireless communication method using an enhanced rule for detection of RTS frames.

FIG. 12 is a schematic diagram showing another embodiment of the wireless communication method using an enhanced rule for detection of RTS frames.

FIG. 13 is a schematic diagram showing another embodiment of the wireless communication method using an enhanced rule for detection of RTS frames.

FIG. 14 is a schematic diagram showing a wireless communication method during transmission according to an embodiment of the invention.

FIG. 15 is a schematic diagram showing an embodiment of the wireless communication method using an enhanced rule for transmission of RTS frames from soft AP MLD.

FIG. 16 is a schematic diagram showing another embodiment of the wireless communication method using an enhanced rule for transmission of RTS frames from soft AP MLD.

FIG. 17 is a schematic diagram showing an example of a EHT variant Common Info field format of a multi-user RTS (MU-RTS) trigger frame.

FIG. 18 is a schematic diagram showing an example of a EHT variant Common Info field format of an MU-RTS trigger frame.

FIG. 19 is a block diagram of a system for wireless communication according to an embodiment of the present disclosure.

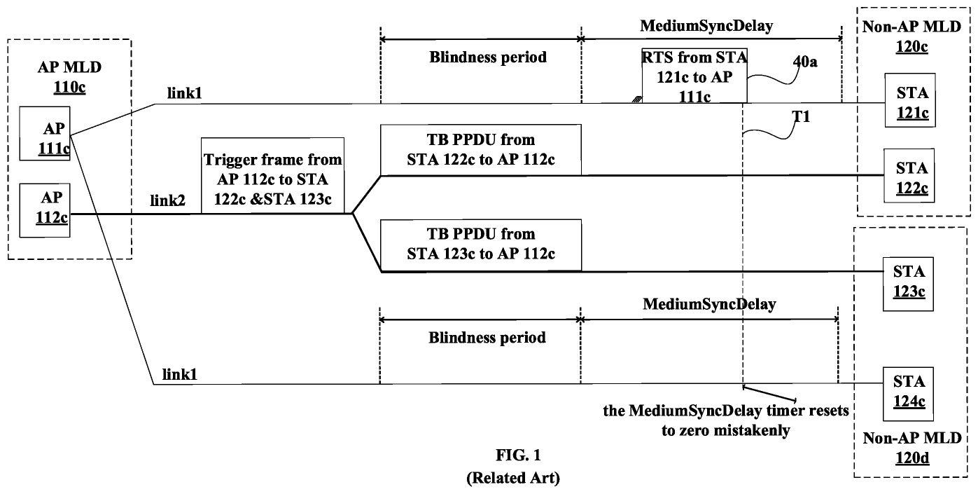

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

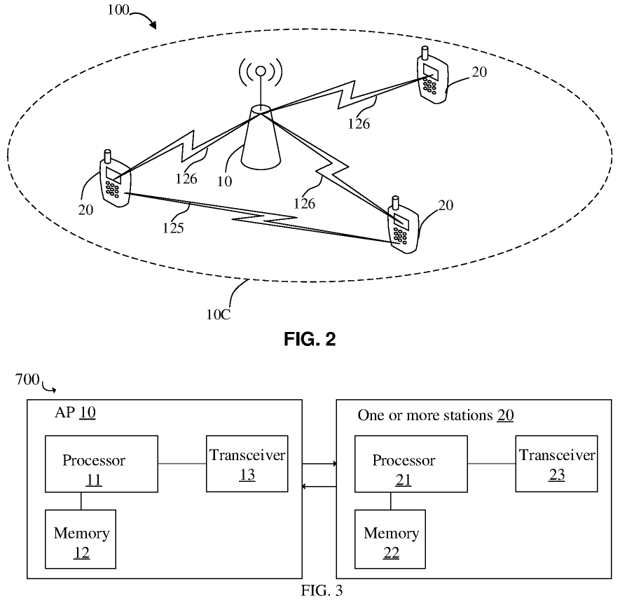

FIG. 2 illustrates an example of a wireless communications system according to an embodiment of the present disclosure. The wireless communications system may be an example of a wireless local area network (WLAN) 100 configured in accordance with various aspects of the present disclosure. The WLAN is also known as a WI-FI network, such as extremely high throughput (EHT), high-efficiency (HE), very high throughput (VHT), and high-throughput (HT) Wi-Fi network. As described herein, the terms extremely high throughput (EHT), high-efficiency (HE), very high throughput (VHT), and high-throughput (HT) may be considered synonymous and may each correspond to a Wi-Fi network supporting a high volume of space-time-streams. The WLAN 100 may include an AP 10 and multiple associated STAs 20, which may represent devices such as mobile stations, personal digital assistant (PDAs), other handheld devices, netbooks, notebook computers, tablet computers, laptops, display devices (such as TVs, computer monitors, etc.), printers, etc. The AP 10 and the associated stations 20 can communicate through WLAN connections 126 and may represent a basic service set (BSS) or an extended service set (ESS). The various STAs 20 in the network can communicate with one another through the AP 10. Also illustrated is a coverage area 10C of the AP 10, which may represent a basic service area (BSA) of the WLAN 100. An extended network station (not shown) associated with the WLAN 100 may be connected to a wired or wireless distribution system that may allow multiple APs 10 to be connected in an ESS.

In some embodiments, an STA 20 may be located in the intersection of more than one coverage area 10C and may associate with more than one AP 10. A single AP 10 and an associated set of STAs 20 may be referred to as a BSS. An ESS is a set of connected BSSs. A distribution system (not shown) may be used to connect APs 10 in an ESS. In some cases, the coverage area 10C of an AP 10 may be divided into sectors (not shown). The WLAN 100 may include APs 10 of different types (such as a metropolitan area, home network, etc.), with varying and overlapping coverage areas 10C. Two STAs 20 also may communicate directly via a direct wireless link 125 regardless of whether both STAs 20 are in the same coverage area 10C. Examples of direct wireless links 125 may include Wi-Fi direct connections, Wi-Fi tunneled direct link setup (TDLS) links, and other group connections. STAs 20 and APs 10 may communicate according to the WLAN radio and baseband protocol for physical and media access control (MAC) layers from IEEE 802.11 and versions including, but not limited to, 802.11b, 802.11g, 802.11a, 802.11n, 802.11ac, 802.11ad, 802.11ah, 802.11ax, 802.11ay, etc. In some other implementations, peer-to-peer connections or ad hoc networks may be implemented within the WLAN 100.

FIG. 3 illustrates one or more stations (STAs) 20 and an access point (AP) 10 of communication in a wireless communications system 700 according to an embodiment of the present disclosure. FIG. 3 illustrates that, the wireless communications system 700 includes an access point (AP) 10 and one or more stations (STAs) 20. The AP 10 may include a memory 12, a transceiver 13, and a processor 11 coupled to the memory 12 and the transceiver 13. The one or more STAs 20 may include a memory 22, a transceiver 23, and a processor 21 coupled to the memory 22 and the transceiver 23. The processor 11 or 21 may be configured to implement proposed functions, procedures and/or methods described in this description. Layers or sublayers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software or computer programs, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21. Solutions in which memory can be communicatively coupled to the processor 11 or 21 via various means as are known in the art.

In some embodiments, the processor 21 is configured to perform the disclosed method in the embodiments of the invention.

IEEE 802.11be Draft 1.1 has specified the medium access recovery procedure. According to the medium access recovery procedure, a first STA, such as the STA 122, and a second STA, such as the STA 121, are affiliated with a non-AP MLD, such as the non-AP MLD 120, that belong to an NSTR link pair. The first STA is considered to have lost medium synchronization due to uplink (UL) interference when the second STA, which is affiliated with the same non-AP MLD and belongs to the NSTR link pair, transmits a PPDU, except when both STAs ended a transmission at the same time.

The first STA that has lost medium synchronization due to a transmission event initiated by the second STA affiliated with the same MLD starts a MediumSyncDelay timer at the end of the transmission event if the transmission event is longer than aMediumSyncThreshold. The aMediumSyncThreshold is a pre-configured parameter for medium synchronization threshold in the standards. The first STA may not start the MediumSyncDelay timer if the transmission event is shorter than or equal to aMediumSyncThreshold.

The MediumSyncDelay timer is a single timer, shared by all enhanced distributed channel access functions (EDCAFs) within a non-AP STA, which is initialized to aPPDUMax Time defined in Table 36-69 in the standards, for extremely high throughput (EHT) physical layer (PHY) characteristics. The STA shall update its MediumSyncDelay timer to the one contained in a medium synchronization field, if present, of the basic variant multi-Link element in the most recent frame received from an associated AP MLD, such as AP MLD 110. The medium synchronization delay timer resets to zero when any of the following events occur:
The first STA receives a PPDU with a valid MPDU; or
The first STA receives a PPDU of which a corresponding RXVECTOR parameter TXOP_DURATION is not UNSPECIFIED.

The first STA affiliated with the non-AP MLD that has a nonzero MediumSyncDelay timer that supports to obtain a TXOP may perform:
transmitting a request to send (RTS) frame as a first frame of any attempt to obtain a TXOP;
attempting to initiate more than MSD_TXOP_MAX TXOPs; and/or
using a CCA_ED threshold that is equal to dot11MSDOFDMEDthreshold.

An AP affiliated with an AP MLD may include the Medium Synchronization Delay Information field in a Basic variant Multi-Link element carried in an Association Response, Beacon, or Probe Response frame. An AP affiliated with an AP MLD shall not include the Medium Synchronization Delay Information field in a Basic variant Multi-Link element carried in an Authentication frame. An STA affiliated with a non-AP MLD shall not include the Medium Synchronization Delay Information field in any Basic variant Multi-Link element it transmits.

A non-AP STA shall initialize dot11MSDOFDMEDthreshold to −72 dBm and MSD_TXOP_MAX to 1, respectively. The non-AP STA affiliated with the non-AP MLD shall set MSD_TXOP_MAX and dot11MSDOFDMEDthreshold to the most recent values in the Medium Synchronization Maximum Number Of TXOPs and Medium Synchronization OFDM ED Threshold subfields, respectively, if they are present in a Basic variant Multi-Link element received from its associated AP MLD.

Note that if either the intra-BSS NAV or the inter-BSS NAV is nonzero in the non-AP STA affiliated with the non-AP MLD when it starts the MediumSyncDelay timer, the non-AP STA does not initiate any TXOP and follow the same rules as an HE STA to respond to any RTS or MU-RTS frame until both NAVs expire. NAV stands for a network allocation vector (NAV).

In the standards during the aCCAtime (see 36.3.20.6.3 (CCA sensitivity for occupying the primary 20 MHz channel)) immediately following the end of the transmission event that caused loss of medium synchronization and subsequent initiation of the MediumSyncDelay timer at the non-AP STA, if the received signal strength exceeds the CCA-ED threshold as given by dot11OFDMEDThreshold for the primary 20 MHz channel and no start of a PPDU is detected, the non-AP STA should defer for extended interframe space (EIFS) beginning when the received signal strength falls below the CCA-ED threshold.

The application provides embodiments of the invention to address the problems in the current specification of medium access recovery procedure in IEEE 802.11be Draft 1.1.

The following description is directed to certain embodiments for the purposes of describing the innovative aspects of the present disclosure. However, a person having ordinary skill in the art will readily recognize that the teachings herein can be applied in a multitude of different ways. The described implementations may be implemented in any device, system, or network that is capable of transmitting and receiving radio frequency (RF) signals according to any of the IEEE 802.11 standards, the Bluetooth® standard, code division multiple access (CDMA), frequency division multiple access (FDMA), time division multiple access (TDMA), global system for mobile communications (GSM), GSM/general packet radio service (GPRS), enhanced data GSM environment (EDGE), terrestrial trunked radio (TETRA), wideband-CDMA (W-CDMA), evolution data optimized (EV-DO), 1×EV-DO, EV-DO Rev A, EV-DO Rev B, high speed packet access (HSPA), high speed downlink packet access (HSDPA), high speed uplink packet access (HSUPA), evolved high speed packet access (HSPA+), long term evolution (LTE), AMPS, or other known signals that are used to communicate within a wireless, cellular or internet of things (IOT) network, such as a system utilizing 3G, 4G, or 5G, or further implementations thereof, technology. Standards in the description may at least refer to one or more versions of the IEEE 802.11 specifications.

IEEE 802.11be Draft 1.1 has specified the medium access recovery mechanism to handle the blindness issue at NSTR non-AP MLD. One potential solution to handle this issue is to specify the rule as follows:
The medium synchronization delay timer resets to zero when any of the following event occur:
   the STA receives a PPDU with a valid MPDU that does not contain an RTS frame

This solution, however, is incomplete. For example, the medium synchronization delay timer can reset to zero when the RTS frame is sent by an STA which has zero MediumSyncDelay timer or has no MediumSyncDelay timer. The current rules for NSTR soft AP MLD is specified as follows:
An STA affiliated with an NSTR soft AP MLD that has a nonzero MediumSyncDelay timer shall use CCA ED threshold that is equal to dot11MSDOFDMEDthreshold and if it intends to obtain a TXOP:
   Shall transmit an RTS frame as the initial frame of an obtained TXOP.
   Shall not attempt to initiate more than MSD_TXOP_MAX TXOPs by transmitting an RTS frame since the start of the medium synchronization delay timer.

This would lead to a problem. For example, an STA affiliated with an NSTR soft AP MLD, which has a nonzero MediumSyncDelay timer is operating on a non-primary link. The STA cannot directly transmit an RTS frame as the initial frame of an obtained TXOP if the other STA in a primary link has not gained a TXOP for transmission.

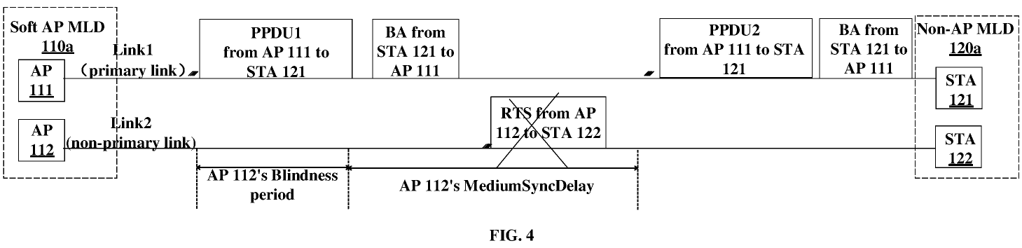

For example, with reference to FIG. 4, an STA 121 and an STA 122 affiliated with a non-AP MLD 120a have their respective nonzero MediumSyncDelay timers. An AP 111 and an AP 112 are affiliated with an AP MLD 110a.

The AP 112 affiliated with an NSTR soft AP MLD 110a, which has a nonzero MediumSyncDelay timer is operating on a non-primary link Link2. The AP 112 cannot directly transmit an RTS frame as the initial frame of an obtained TXOP if the other AP (i.e., AP 111) affiliated with the NSTR soft AP MLD 110a in a primary link has not gained a TXOP for transmission.

The innovation proposes some solutions to solve the problems existing in the current specification of medium access recovery mechanism in IEEE 802.11be Draft 1.1.

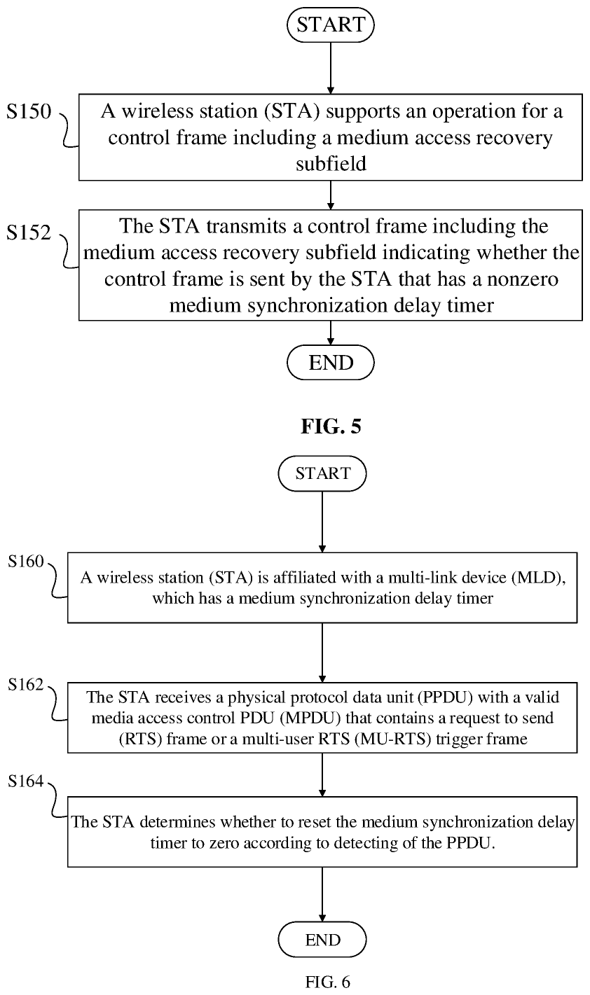

With reference to FIG. 5, a wireless station (STA) supports an operation for a control frame including a medium access recovery subfield (step S150). The STA transmits a control frame including a medium access recovery subfield indicating whether the control frame is sent by the STA that has a nonzero medium synchronization delay timer (step S152). In an embodiment of the invention, the control frame including the medium access recovery subfield is a multi-user RTS (MU-RTS) trigger frame. In another embodiment of the invention, the control frame including the medium access recovery subfield is a RTS frame.

The wireless device starts a medium synchronization delay timer at an end of a blindness period of the wireless device to time a medium synchronization delay period when the wireless device affiliated with a non-access point multi-link device (non-AP MLD) that belongs to a wireless link pair has lost medium synchronization, wherein the medium synchronization delay timer times the medium synchronization delay period. The medium synchronization delay timer may comprise the MediumSyncDelay timer, and the medium synchronization delay period may comprise the MediumSyncDelay period timed by the MediumSyncDelay timer. The wireless device detects the wireless link pair for a transmission event on at least one link of the wireless link pair to obtain a detection result.

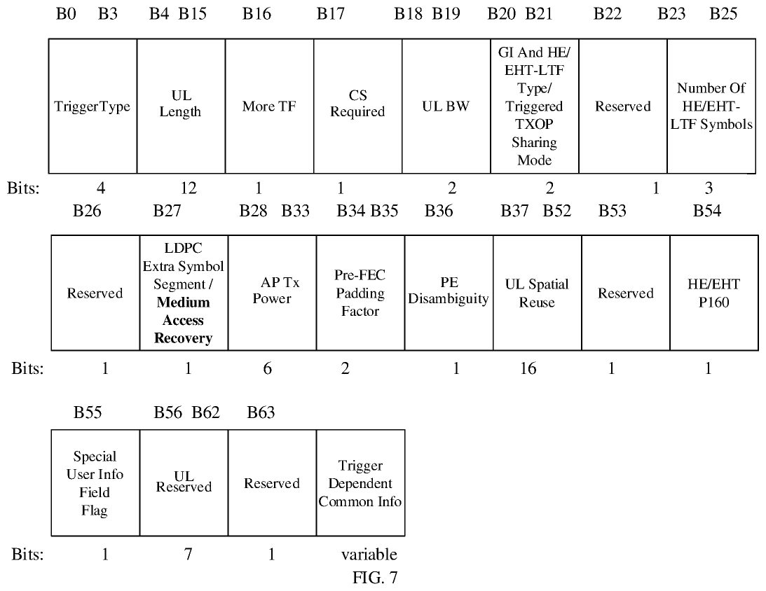

With reference to FIG. 6, a wireless station (STA) is affiliated with a multi-link device (MLD), which has a medium synchronization delay timer (step S160). The STA receives a physical protocol data unit (PPDU) with a valid media access control PDU (MPDU) that contains a request to send (RTS) frame or a multi-user RTS (MU-RTS) trigger frame (step S162). The STA determines whether to reset the medium synchronization delay timer to zero according to detecting of the PPDU (step S164).

The wireless device determines whether to adjust the medium synchronization delay period based on the detection result. The wireless device may adjust the medium synchronization delay period by starting, resetting, or restarting the medium synchronization delay timer. The wireless device may determine a first corresponding rule to adjust the medium synchronization delay period according to the detection result and apply the first corresponding rule accordingly.

A first STA, such as the STA 122, that has lost medium synchronization due to a transmission event performed by a second STA, such as the STA 121, affiliated with the same MLD, such as the non-AP MLD 120, starts the MediumSyncDelay timer at the end of the transmission event if the transmission event is longer than the aMediumSyncThreshold. The first STA may use one or several or all of the following solutions or rules in the embodiments during the period of the MediumSyncDelay timer when the MediumSyncDelay is not equal to 0.

In the following, STAs 121, 122, and 123 are examples of the STA 20. AP 111, 112, and 113 are examples of the AP 10.

### Embodiment 1

### 1) To Specify the Medium Access Recovery Subfield in the Common Info Field of a MU-RTS (Multi-User RTS) Trigger Frame:

In an embodiment of the invention, the control frame including the medium access recovery subfield is a multi-user RTS (MU-RTS) trigger frame.

A Medium Access Recovery subfield in the Common Info field of the MU-RTS Trigger frame indicates whether the MU-RTS Trigger frame is sent by an STA that has a nonzero MediumSyncDelay timer. A value of 1 in the Medium Access Recovery subfield indicates that the MU-RTS Trigger frame is sent by an STA that has a nonzero MediumSyncDelay timer. Otherwise, a value of 0 in the Medium Access Recovery subfield indicates that the MU-RTS Trigger frame is sent by an STA that has a zero MediumSyncDelay timer, or has no MediumSyncDelay timer.

For example, optional EHT variant Common Info field formats of a Trigger frame contain the Medium Access Recovery subfield for the MU-RTS Trigger frame are shown in FIG. 7 to FIG. 9. The Medium Access Recovery subfield is present in an MU-RTS Trigger frame.

### 2) To Add the Following Rules for Medium Access Recovery Mechanism:

In an embodiment of the invention, the one or more of following rules in Table 1 are included in a medium access recovery mechanism:

TABLE 1

| ● | A non-AP STA affiliated with a non-AP MLD, which has a nonzero MediumSyncDelay | |
|---|---|---|
| | timer and supports to obtain a TXOP shall: | |
| | ▪ | transmit an RTS frame or MU-RTS Trigger frame in which a value of the Medium |
| | | Access Recovery subfield is 1, as the first frame of any attempt to obtain a |
| | | Transmission opportunity (TXOP); |
| ● | The STA doesn't reset the medium synchronization delay timer (i.e., MediumSyncDelay | |
| | timer) to zero when the following event occur: | |
| | ▪ | - The STA receives a PPDU with a valid MPDU that contains an MU-RTS |
| | | Trigger frame in which a value of the Medium Access Recovery subfield is 1. |
| ● | The STA resets the medium synchronization delay timer to zero when the following event | |
| | occur: | |
| | ▪ | - The STA receives a PPDU with a valid MPDU that contains an MU-RTS |

Trigger frame in which a value of the Medium Access Recovery subfield is 0.

A first value, such as 1, in the medium access recovery subfield indicates that the MU-RTS Trigger frame is sent by the STA that has a nonzero medium synchronization delay. A second value, such as 0, in the medium access recovery subfield indicates that the MU-RTS Trigger frame is sent by the STA that has a zero medium synchronization delay timer (e.g., the MediumSyncDelay timer), or does not has any medium synchronization delay timer (e.g., the MediumSyncDelay timer).

According to at least one of the rules, the STA is a non-AP STA affiliated with a non-access-point (non-AP) multi-link device (MLD), and the non-AP STA has a nonzero medium synchronization delay timer (e.g., the MediumSyncDelay timer) and supports to obtain a TXOP. The STA transmits an MU-RTS Trigger frame in which a value of the medium access recovery subfield is the first value, as the first frame of any attempt to obtain a TXOP.

According to at least one of the rules, the STA doesn't reset the medium synchronization delay timer (e.g., the MediumSyncDelay timer) to zero when the STA receives a PPDU with a valid MPDU that contains an MU-RTS Trigger frame in which a value of the medium access recovery subfield is the first value. The STA resets the medium synchronization delay timer (e.g., the MediumSyncDelay timer) to zero when the STA receives a PPDU with a valid MPDU that contains an MU-RTS Trigger frame in which a value of the medium access recovery subfield is the second value.

For example, as shown in the FIG. 7, the medium access recovery subfield is located in the 28th bit B27 of EHT variant Common Info field of a MU-RTS trigger frame. The 28th bit B27 of EHT variant Common Info field format of a Trigger frame is originally for configuration of Low-density parity-check code (LDPC) extra symbol segment.

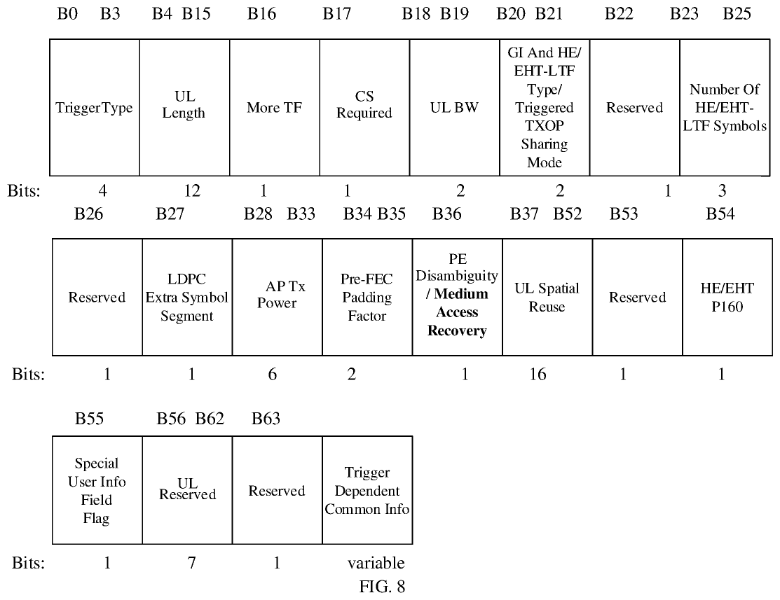

For example, as shown in the FIG. 8, the medium access recovery subfield is located in the 37th bit B36 of EHT variant Common Info field of a MU-RTS trigger frame. The 37th bit B36 of EHT variant Common Info field format of a Trigger frame is originally for configuration of PE disambiguity.

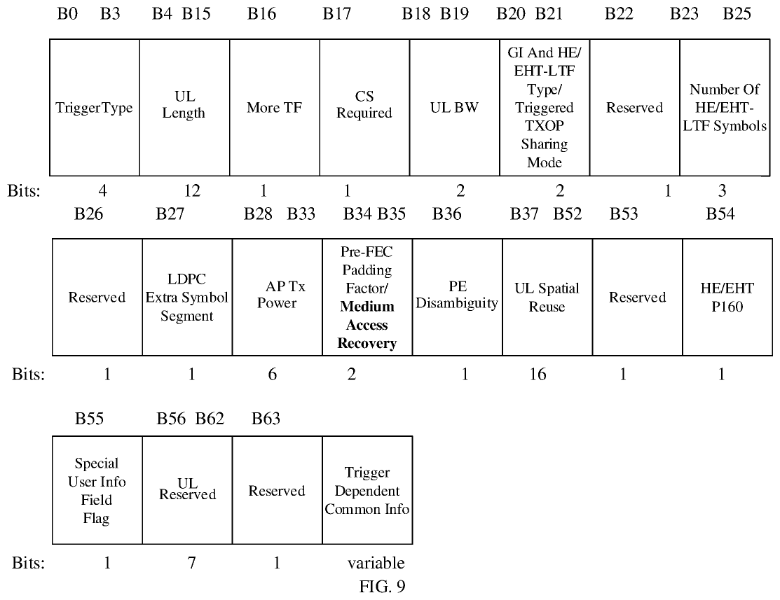

For example, as shown in the FIG. 9, the medium access recovery subfield is located in the 35th to 36th bits (i.e., bits B34 to B35) of EHT variant Common Info field of a MU-RTS trigger frame. The bits B34 to B35 of EHT variant Common Info field format of a Trigger frame are originally for configuration of Pre-FEC Padding Factor.

### Embodiment 2

In an embodiment of the invention, the one or more of following rules in Table 2 are included in a medium access recovery mechanism:

TABLE 2

| ● | An STA is affiliated with an MLD and has a nonzero MediumSyncDelay timer. When the | |
|---|---|---|
| | STA receives a PPDU with a valid MPDU that contains an RTS frame, the STA determine | |
| | whether to reset the MediumSyncDelay timer to zero during a given time interval. The STA | |
| | should: | |
| | ▪ | not reset the medium synchronization delay timer to zero if the nonzero |
| | | MediumSyncDelay timer is nonzero and no PHY-RXSTART.indication primitive |
| | | is received from the physical layer (PHY) during a NAVTimeout period starting |
| | | when the media access control layer (MAC) receives a PHY-RXEND.indication |
| | | primitive corresponding to the detection of the RTS frame; and/or |
| | ▪ | reset the medium synchronization delay timer to zero if the nonzero |

MediumSyncDelay timer is nonzero and PHY-RXSTART.indication primitive is
received from the PHY during a NAVTimeout period starting when the MAC
receives a PHY-RXEND.indication primitive corresponding to the detection of the
RTS frame.

The PHY-RXSTART.indication primitive is an indication by the PHY to the local MAC entity that the PHY has received a valid start of a PPDU, including a valid PHY header. The primitive provides the following parameter:
PHY-RXSTART.indication(
RXVECTOR)
   The RXVECTOR represents a list of parameters that the PHY provides the local MAC entity upon receipt of a valid PHY header. The PHY-RXEND.indication primitive is an indication by the PHY to the local MAC entity that the PPDU currently being received is complete. In non-DMG BSS, NAVTimeout period is equal to (2×aSIFSTime)+(CTS_Time)+aRxPHYStartDelay+(2×aSlotTime). In a non-SIG STA, the CTS_Time shall be calculated using the length of the CTS frame and a data rate at which the RTS frame used for the most recent NAV update was received. The terms and parameters are detailed in the following:
DMG:DMG stands for directional multi-gigabit (DMG).
The aSIFSTime: The aSIFSTime is the nominal time (in microseconds) that the MAC and PHY require for receiving the last symbol of a frame on the WM, processing the frame, and responding with the first symbol on the WM of the earliest possible response frame.
CTS_Time: In a non-S1G STA, the CTS_Time shall be calculated using the length of the CTS frame and the data rate at which the RTS frame used for the most recent NAV update was received. In an SIG STA, the CTS_Time shall be calculated using the time required to transmit an NDP CTS frame that is equal to NDPTxTime.
ARxPHY StartDelay: The delay (in microseconds) from the start of the PPDU at the receiver's antenna to the issuance of the PHY-RXSTART.indication primitive.
aSlotTime: The slot time (in microseconds) that the MAC uses for defining IFSs.
SIG: Sub 1 GHz (S1G).

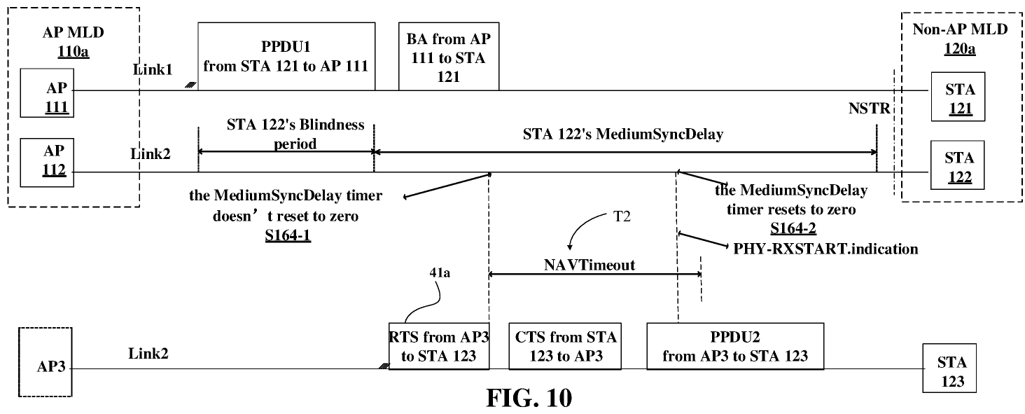

With reference to FIG. 10, according to at least one of the rules, the STA (e.g., STA 122) does not reset (S164-1) the medium synchronization delay timer to zero when a MAC of the STA receives a PHY-RXEND.indication primitive corresponding to detection of the RTS frame (e.g., RTS frame 41a) if the STA has the nonzero medium synchronization delay timer.

According to at least one of the rules, the STA (e.g., STA 122) resets (S164-2) the medium synchronization delay timer to zero if the medium synchronization delay timer is nonzero and a PHY-RXSTART.indication primitive is received from a PHY of the STA during a NAVTimeout period, wherein the NAVTimeout period starts when a MAC of the STA receives a PHY-RXEND.indication primitive corresponding to detection of the RTS frame (e.g., RTS frame 41a).

### Embodiment 3

The MediumSyncDelay timer is used for the STA affiliated with an MLD that operates on an NSTR link pair, and an STA affiliated with an MLD that operates on a STR link pair does not need to start a MediumSyncDelay timer. In an embodiment of the invention, the one or more of following rules in Table 3 are included in a medium access recovery mechanism:

TABLE 3

| ● | An STA is affiliated with an MLD and has a nonzero MediumSyncDelay timer. The STA | |
|---|---|---|
| | resets the medium synchronization delay timer to zero when the following event occurs: | |
| | ▪ | the STA receives a PPDU with a valid MPDU that contains an RTS frame, and the |

transmitter address (TA) of the RTS frame is an address of an STA (e.g., an AP
STA or non-AP STA) affiliated with an MLD, which is not operating on an NSTR
pair, or an address of an STA (e.g., an AP STA or non-AP STA) which is not
affiliated with an MLD.

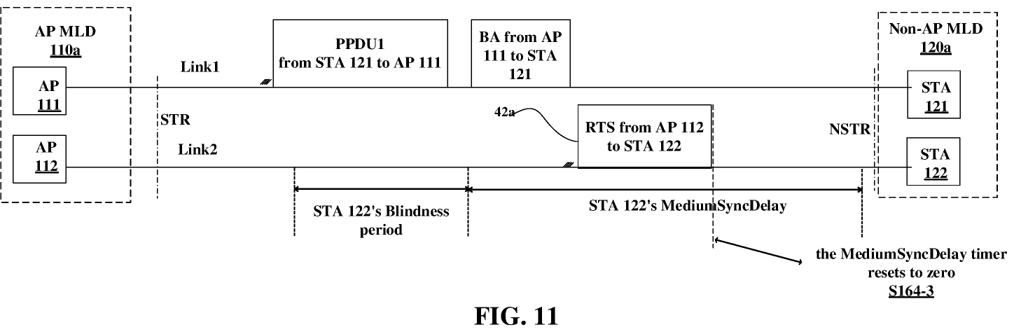

With reference to FIG. 11, according to at least one of the rules, the STA (e.g., STA 122) resets (S164-3) the medium synchronization delay timer to zero when the STA receives a PPDU with the valid MPDU that contains an RTS frame (e.g., RTS frame 42a), and a transmitter address (TA) of the RTS frame (e.g., RTS frame 42a) is an address of an AP (e.g., AP112) affiliated with an AP MLD (e.g., AP MLD 110a), which is not operating on an NSTR pair. According to at least one of the rules, the STA resets the medium synchronization delay timer to zero when the STA receives a PPDU with the valid MPDU that contains an RTS frame, and a transmitter address (TA) of the RTS frame is an address of an AP which is not affiliated with an MLD.

For example, the transmitter address (TA) of the RTS frame 42a is the address of the AP 112 affiliated with an AP MLD and that is not operating on an NSTR pair.

### Embodiment 4

In an embodiment of the invention, the one or more of following rules in Table 4 are included in a medium access recovery mechanism:

TABLE 4

| ● | An STA is affiliated with a non-AP MLD that is associated with an NSTR soft AP MLD, | |
|---|---|---|
| | and the STA is operating on the nonprimary link and has a nonzero MediumSyncDelay | |
| | timer. The STA resets the medium synchronization delay timer to zero when the following | |
| | event occurs: | |
| | ▪ | The STA receives a PPDU with a valid MPDU that contains an RTS frame, and |
| | | the RTS frame is sent by the AP of the soft AP MLD with which the STA is |
| | | associated, and the time interval between the start of the RTS frame and the end |
| | | of the PPDU the most recently transmitted by the other AP of the soft AP MLD in |
| | | the primary link is longer than or equal to MediumSyncDelay and the transmission |
| | | event of the PPDU the most recently transmitted by the other AP is longer than |
| | | aMediumSyncThreshold. And the PPDU transmitted by the other AP of the soft |
| | | AP MLD can be detected by the other STA affiliated with the same non-AP MLD |
| | | in the primary link. |
| ● | An STA is affiliated with a non-AP MLD that is associated with an NSTR soft AP MLD, | |
| | and the STA is operating on the nonprimary link and has a nonzero MediumSyncDelay | |
| | timer. The STA doesn't reset the medium synchronization delay timer to zero when the | |
| | following event occurs: | |
| | ▪ | The STA receives a PPDU with a valid MPDU that contains an RTS frame, and |

the RTS frame is sent by the AP of the soft AP MLD with which the STA is
associated, and a time interval between the start of the RTS frame and the end of
the PPDU the most recently transmitted by the other AP of the soft AP MLD in
the primary link and whose transmission event is longer than
aMediumSyncThreshold, is shorter than MediumSyncDelay. And the PPDU
transmitted by the other AP of the soft AP MLD can be detected by the other STA
affiliated with the same non-AP MLD in the primary link.

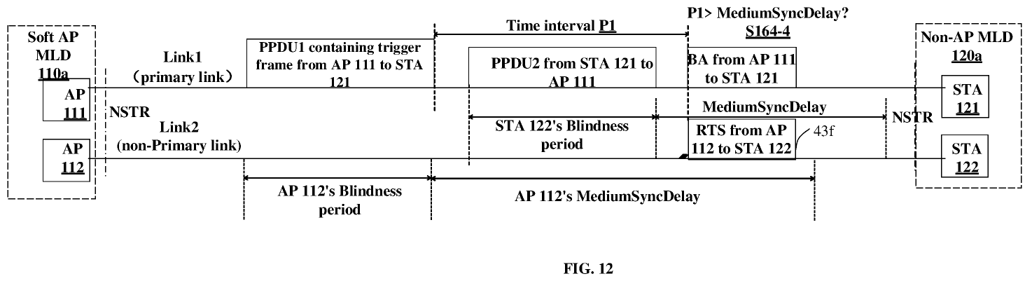

With reference to FIG. 12, according to at least one of the rules, the STA resets (S164-4) the medium synchronization delay timer to zero when the STA (e.g., STA 122) receives a PPDU with a valid MPDU that contains an RTS frame (e.g., RTS frame 43f), and the RTS frame is sent by an AP (e.g., AP 112) an NSTR soft AP MLD (e.g., soft AP MLD 110a) with which the STA (e.g., STA 122) is associated in the nonprimary link, and a time interval (e.g., time interval P1) between the end time of a PPDU (e.g., PPDU1) the most recently transmitted by the other AP (e.g., AP 111) affiliated with the soft AP MLD (e.g., soft AP MLD 110a) in a primary link, which is detectable by the other STA affiliated with the same MLD as the STA, and the start of the reception of the PPDU with the valid MPDU that contains the RTS frame (e.g., RTS frame 43f) is longer than or equal to MediumSyncDelay (i.e., the Medium Synchronization duration of the MediumSyncDelay timer) and the transmission event (e.g., a length of PPDU1) of the PPDU (e.g., PPDU1) the most recently transmitted by the other AP (e.g., AP 111) affiliated with the same soft AP MLD is longer than aMediumSyncThreshold. The PPDU (e.g., PPDU1) transmitted by the other AP of the soft AP MLD can be detected by the other STA (e.g., STA 121) affiliated with the same non-AP MLD (e.g., STA 120a) in the primary link.

According to at least one of the rules, the STA does not reset (S164-4) the medium synchronization delay timer to zero when the STA (e.g., STA 122) receives a PPDU with a valid MPDU that contains an RTS frame (e.g., RTS frame 43f), and the RTS frame is sent by an AP (e.g., AP 112) affiliated with an NSTR soft AP MLD (e.g., soft AP MLD 110a) with which the STA is associated in the nonprimary link, and a time interval (e.g., time interval P1) between the end time of a PPDU (e.g., PPDU1) the most recently transmitted by the other AP (e.g., AP 111) affiliated with the same soft AP MLD (e.g., soft AP MLD 110a) in the primary link and the start of the reception of the PPDU with MPDU that contains the RTS frame (e.g., RTS frame 43f) is shorter than MediumSyncDelay and the transmission event (e.g., a length of PPDU1) of the PPDU (e.g., PPDU1) the most recently transmitted by the other AP (e.g., AP 111) affiliated with the same soft AP MLD in the primary link is longer than aMediumSyncThreshold. The PPDU (e.g., PPDU1) transmitted by the other AP of the soft AP MLD can be detected by the other STA (e.g., STA 121) affiliated with the same non-AP MLD (e.g., STA 120a) in the primary link.

### Embodiment 5

In an embodiment of the invention, the one or more of following rules in Table 5 are included in a medium access recovery mechanism:

TABLE 5

| ● | An STA affiliated with an MLD, which has a nonzero MediumSyncDelay timer resets the | |
|---|---|---|
| | medium synchronization delay timer to zero when any of the following events occur: | |
| | ▪ | the STA receives a PPDU with a valid MPDU that contains an RTS frame, and the |
| | | transmitter address (TA) of the RTS frame is an address of the TDLS peer STA |
| | | affiliated with an MLD and that is not operating on an NSTR pair, or an address |
| | | of a TDLS peer STA which is not affiliated with an MLD; and/or |
| | ▪ | the STA receives a PPDU with a valid MPDU that contains an RTS frame, and |

the RTS frame is sent from the TDLS peer STA affiliated with an MLD and that
is not operating on an NSTR pair, or from a TDLS peer STA which is not affiliated
with an MLD.

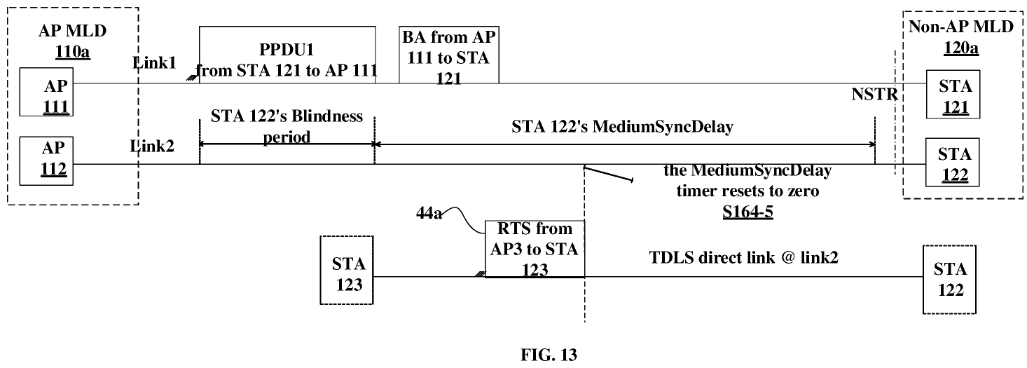

With reference to FIG. 13, an STA affiliated with a non-AP MLD has a nonzero MediumSyncDelay timer. According to at least one of the rules, the STA (e.g., STA 122) resets (S164-5) the medium synchronization delay timer to zero when the STA (e.g., STA 122) receives a PPDU that contains an RTS frame (e.g., RTS frame 44a), and the transmitter address (TA) of the RTS frame (e.g., RTS frame 44a) is an address of a TDLS peer STA (e.g., STA 123) affiliated with another MLD, which is not operating on an NSTR pair, or an address of a TDLS peer STA (e.g., STA 123) which is not affiliated with an MLD.

According to at least one of the rules, the STA (e.g., STA 122) resets (S164-5) the medium synchronization delay timer to zero when the STA (e.g., STA 122) receives a PPDU with a valid MPDU that contains an RTS frame (e.g., RTS frame 44a), and the RTS frame (e.g., RTS frame 44a) is sent from a TDLS peer STA (e.g., STA 123) affiliated with another MLD, which is not operating on an NSTR pair, or from a TDLS peer STA (e.g., STA 123) which is not affiliated with an MLD.

### Embodiment 6

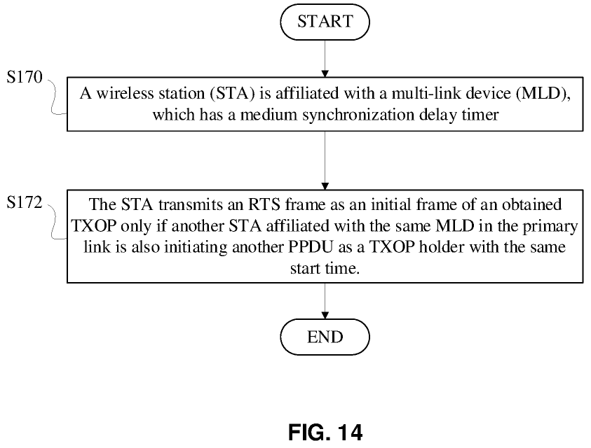

With reference to FIG. 14, the wireless station (STA) affiliated with a soft AP MLD in a nonprimary link has a medium synchronization delay timer (S170). The STA transmits an RTS frame as an initial frame of an obtained TXOP only if another STA affiliated with the same MLD in the primary link is also initiating another PPDU as a TXOP holder with the same start time (S172).

In an embodiment of the invention, the one or more of following rules in Table 6 are included in a medium access recovery mechanism:

TABLE 6

| ● | An STA is affiliated with a soft AP MLD in a nonprimary link, has a nonzero | |
|---|---|---|
| | MediumSyncDelay timer, and intends to obtain a TXOP, and the STA shall: | |
| | ▪ | transmit an RTS frame as an initial frame of an obtained TXOP only if another |

STA affiliated with the same MLD in the primary link is also initiating another
PPDU as a TXOP holder with the same start time.

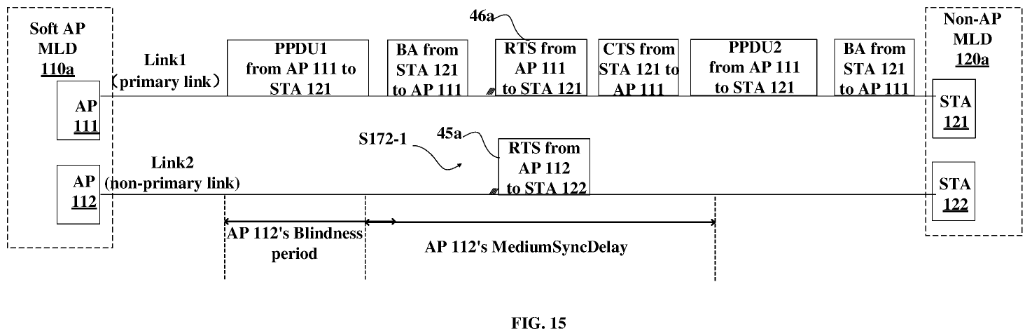

With reference to FIG. 15, according to at least one of the rules, the AP (e.g., AP 112) is affiliated with an NSTR soft AP MLD (e.g., soft AP MLD 110a) in a nonprimary link (e.g., Link2), has a nonzero MediumSyncDelay timer, and when capable of obtaining a TXOP the STA (e.g., AP STA 111) transmits (S172-1) an RTS frame (e.g., RTS frame 45a) as an initial frame of an obtained TXOP to its associated non-AP STA in the nonprimary link only if another STA (e.g., AP STA 112) affiliated with the same soft AP MLD (e.g., soft AP MLD 110a) in the primary link (e.g., Link1) is also initiating another PPDU (e.g., RTS frame 46a) as a TXOP holder or another STA affiliated with the same soft AP MLD in the primary link is also transmitting another PPDU at the same time.

For example, an STA 112 is affiliated with an NSTR soft AP MLD 110a in the nonprimary link Link2, has a nonzero MediumSyncDelay timer. When capable of obtaining a TXOP, the STA 112 transmits an RTS frame 45a as the initial frame of an obtained TXOP to its associated non-AP STA in the nonprimary link when the STA 111 affiliated with the same soft AP MLD 110a in the primary link Link1 is also initiating the PPDU that contains an RTS frame 46a as a TXOP holder or another STA affiliated with the same soft AP MLD in the primary link is also transmitting another PPDU at the same time. The PPDU in the primary link Link1 may be a PPDU which carries the RTS frame 46a.

### Embodiment 7

In an embodiment of the invention, the one or more of following rules in Table 7 are included in a medium access recovery mechanism:

TABLE 7

| ● | An STA is affiliated with a non-AP MLD that is associated with an NSTR soft AP MLD. | |
|---|---|---|
| | The STA is in a nonprimary link and has a nonzero MediumSyncDelay timer. The STA | |
| | intending to obtain a TXOP should: | |
| | ▪ | transmit an RTS frame as an initial frame of an obtained TXOP only if another |

STA affiliated with the same non-AP MLD in a primary link is also initiating
another PPDU as a TXOP holder with the same start time.

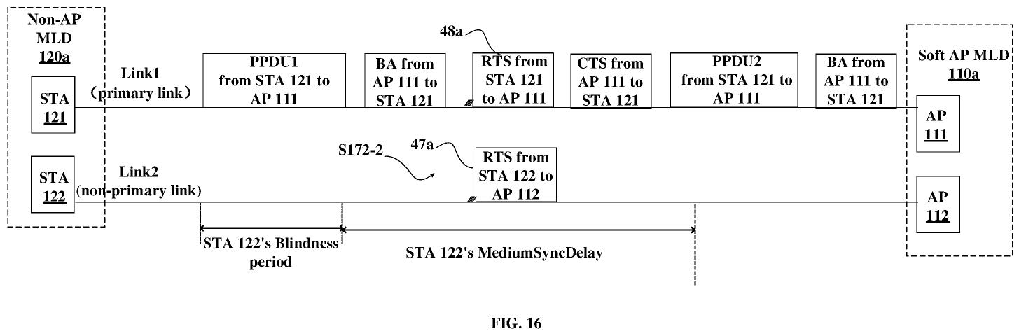

With reference to FIG. 16, according to at least one of the rules, the STA (e.g., STA 122) is affiliated with a non-AP MLD (e.g., non-AP MLD 120a) that is associated with an NSTR soft AP MLD (e.g., soft AP MLD 110a), the STA (e.g., STA 122) is in a nonprimary link (e.g., Link2) and has a nonzero MediumSyncDelay timer, and the STA (e.g., STA 122) that intends to obtain a TXOP may transmit (S172-2) an RTS frame (e.g., RTS frame 47a) as an initial frame of an obtained TXOP only if another STA (e.g., STA 121) affiliated with the same non-AP MLD (e.g., non-AP MLD 120a) in the primary link (e.g., Link1) is also initiating another PPDU (e.g., RTS frame 48a) as a TXOP holder or the STA affiliated with the same non-AP MLD in the primary link is also transmitting the PPDU at the same time.

For example, an STA 122 is affiliated with the non-AP MLD 120a that is associated with an NSTR soft AP MLD 110a, and the STA 122 is in the nonprimary link Link2 and has a nonzero MediumSyncDelay timer and intends to obtain a TXOP, transmits an RTS frame 47a as the initial frame of an obtained TXOP when the STA 121 affiliated with the same non-AP MLD 120a in the primary link Link1 is also initiating the PPDU that contains an RTS frame 48a as a TXOP holder with the same start time.

### Embodiment 8

1) Specify the Medium Access Recovery Subfield in the Frame Control Field within RTS Frame

The Medium Access Recovery subfield in the Frame Control field within RTS frame indicates whether the RTS frame is sent by an STA that has a nonzero MediumSyncDelay timer. A value of 1 in the Medium Access Recovery subfield indicates that the RTS frame is sent by an STA that has a nonzero MediumSyncDelay timer. Otherwise, a value of 0 in the Medium Access Recovery subfield indicates that the RTS frame is sent by an STA that has a zero MediumSyncDelay timer, or has no MediumSyncDelay timer.

### 2) Add the Following Rule for Medium Access Recovery Mechanism

In an embodiment of the invention, the one or more of following rules in Table 8 are included in a medium access recovery mechanism:

TABLE 8

| ● | A non-AP STA affiliated with non-AP MLD, which has a nonzero MediumSyncDelay | |
|---|---|---|
| | timer and supports to obtain a TXOP shall: | |
| | ▪ | -transmit an RTS frame in which a value of the Medium Access Recovery |
| | | subfield is 1, as the first frame of any attempt to obtain a TXOP. |
| ● | And the medium synchronization delay timer doesn't reset to zero when the following | |
| | event occur: | |
| | ▪ | The STA receives a PPDU with a valid MPDU that contains an RTS frame in |
| | | which a value of the Medium Access Recovery subfield is 1. |
| ● | the medium synchronization delay timer resets to zero when the following event | |
| | occur: | |
| | ▪ | The STA receives a PPDU with a valid MPDU that contains an RTS frame in |

which a value of the Medium Access Recovery subfield is 0

In an embodiment of the invention, the control frame including the medium access recovery subfield is a request to send (RTS) frame.

A first value, such as 1, in the medium access recovery subfield indicates that the RTS frame is sent by the STA that has a nonzero medium synchronization delay. A second value, such as 0, in the medium access recovery subfield indicates that the RTS frame is sent by the STA that has a zero medium synchronization delay timer (e.g., the MediumSyncDelay timer), or does not has any medium synchronization delay timer (e.g., the MediumSyncDelay timer).

According to at least one of the rules, the STA is a non-AP STA affiliated with a non-access-point (non-AP) multi-link device (MLD). The non-AP STA has a nonzero medium synchronization delay timer (e.g., the MediumSyncDelay timer) and supports to obtain a TXOP. The STA transmits an RTS frame in which a value of the medium access recovery subfield is the first value, as the first frame of any attempt to obtain a TXOP.

According to at least one of the rules, the STA is a non-AP STA affiliated with a non-access-point (non-AP) multi-link device (MLD). The non-AP STA has a nonzero MediumSyncDelay timer and supports to obtain a TXOP, and the STA doesn't reset the medium synchronization delay timer (e.g., the MediumSyncDelay timer) to zero when the STA receives a PPDU with a valid MPDU that contains an RTS frame in which a value of the medium access recovery subfield is the first value. The STA resets the medium synchronization delay timer (e.g., the MediumSyncDelay timer) to zero when the STA receives a PPDU with a valid MPDU that contains an RTS frame in which a value of the medium access recovery subfield is the second value.

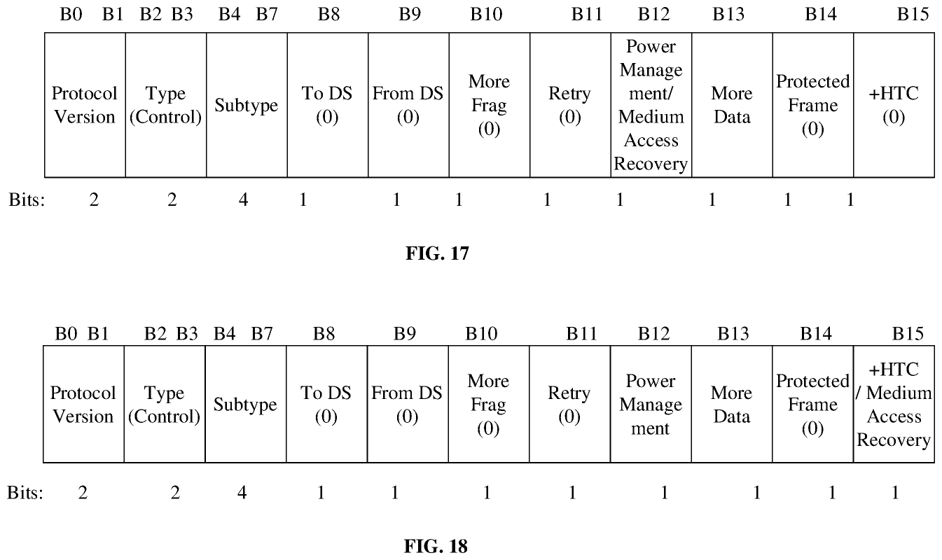

For example, as shown in FIG. 17, the medium access recovery subfield is located in the 13th bit B12 of the Frame Control field of a RTS frame. The 13th bit B12 is originally for configuration of power management.

For example, as shown in FIG. 18, the medium access recovery subfield is located in the 16th bit B15 of the Frame Control field of a RTS frame. The 16th bit B15 is originally for configuration of HT control (+HTC) field. A frame that contains the HT Control field is referred to as a +HTC frame.

Two or more of the embodiments may be combined. An STA may perform the wireless communication method according to the embodiments of any combination thereof.

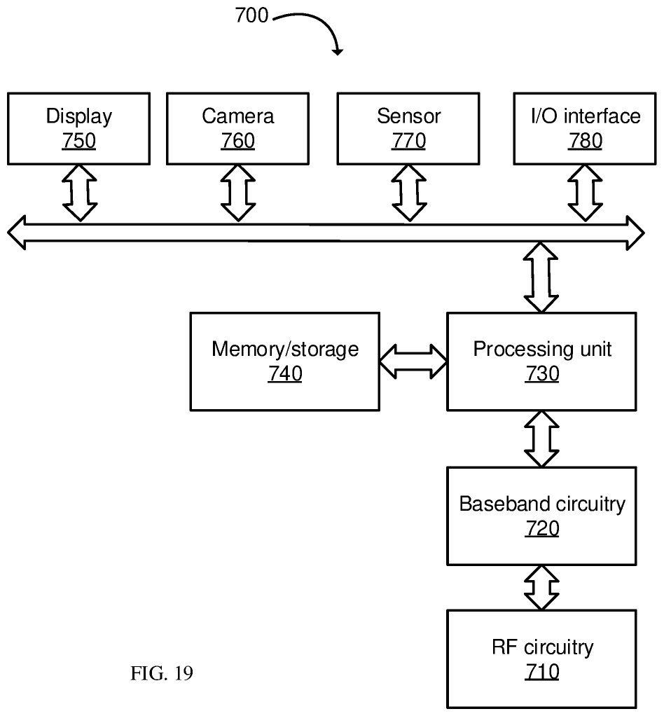

FIG. 19 is a block diagram of an example system 700 for wireless communication according to an embodiment of the present disclosure. Embodiments described herein may be implemented into the system using any suitably configured hardware and/or software. FIG. 19 illustrates the system 700 including a radio frequency (RF) circuitry 710, a baseband circuitry 720, a processing unit 730, a memory/storage 740, a display 750, a camera 760, a sensor 770, and an input/output (I/O) interface 780, coupled with each other as illustrated.

The processing unit 730 may include circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 720 may include circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the MLD, STA or AP may be embodied in whole or in part in one or more of the RF circuitries, the baseband circuitry, and/or the processing unit. As used herein, “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the processing unit, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory. In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite. In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, etc. In various embodiments, system may have more or less components, and/or different architectures. Where appropriate, the methods described herein may be implemented as a computer program. The computer program may be stored on a storage medium, such as a non-transitory storage medium.

The embodiment of the present disclosure is a combination of techniques/processes that can be adopted in IEEE 802.11be specification to create an end product.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized in other ways. The above-mentioned embodiments are exemplary only. The division of the units is merely based on logical functions while other divisions exist in realization. It is possible that a plurality of units or components are combined or integrated into another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated into one processing unit, physically independent, or integrated into one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

Medium access recovery for NSTR MLD is an important function specified in the next-generation Wi-Fi standard IEEE 802.11be. Some of the solutions described in this disclosure can be included in 802.11be standard, and then be adopted in the Wi-Fi AP and mobile phones. Embodiments of the invention provides a wireless communication method for medium access recovery utilizing enhanced rules for trigger frame detection and transmission. The disclosed method prevents erroneous reset of a medium synchronization delay timer and inefficient waiting time before RTS frame transmission.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A wireless communication method for medium access recovery, comprising:
a wireless station (STA) affiliated with a multi-link device (MLD), which has a nonzero medium synchronization delay (MediumSyncDelay) timer, when receiving a physical protocol data unit (PPDU) with a valid media access control protocol data unit (MPDU) that contains a request to send (RTS) frame or a multi-user RTS (MU-RTS) trigger frame, determining whether to reset the MediumSyncDelay timer to zero according to detecting of the PPDU; or
a STA, that supports an operation for a control frame including a medium access recovery subfield, transmitting a control frame including a medium access recovery subfield indicating whether the control frame is sent by the STA that has a nonzero MediumSyncDelay timer if needed.

2. A wireless station (STA) comprising:
a processor, configured to call and run a computer program stored in a memory, to cause a device in which a chip is installed to execute a method, wherein the method comprises:
the STA affiliated with a multi-link device (MLD), which has a nonzero medium synchronization delay (MediumSyncDelay) timer, when receiving a physical protocol data unit (PPDU) with a valid media access control protocol data unit (MPDU) that contains a request to send (RTS) frame or a multi-user RTS (MU-RTS) trigger frame, determining whether to reset the MediumSyncDelay timer to zero according to detecting of the PPDU; or
the STA, that supports an operation for a control frame including a medium access recovery subfield, transmitting a control frame including a medium access recovery subfield indicating whether the control frame is sent by the STA that has a nonzero MediumSyncDelay timer if needed.

3. The STA of claim 2, wherein in response to the STA being affiliated with an MLD, the STA determines whether to reset the MediumSyncDelay timer to zero according to detecting of the PPDU during a given time interval.

4. The STA of claim 2, wherein in response to the STA being affiliated with an MLD, the STA does not reset the MediumSyncDelay timer to zero if the MediumSyncDelay timer is nonzero and no PHY-RXSTART.indication primitive is received from a physical layer (PHY) of the STA during a NAVTimeout period, wherein the NAVTimeout period starts when a media access control layer (MAC) of the STA receives a PHY-RXEND.indication primitive corresponding to detection of the RTS frame; and/or
in response to the STA being affiliated with an MLD, the STA resets the MediumSyncDelay timer to zero if the MediumSyncDelay timer is nonzero and a PHY-RXSTART.indication primitive is received from a PHY of the STA during a NAVTimeout period, wherein the NAVTimeout period starts when a MAC of the STA receives a PHY-RXEND.indication primitive corresponding to detection of the RTS frame;
wherein in non-DMG BSS, the NAVTimeout period is equal to (2×aSIFSTime)+(CTS_Time)+aRxPHYStartDelay+(2×aSlotTime).

5. The STA of claim 2, wherein in response to the STA being affiliated with an MLD, the STA resets the MediumSyncDelay timer to zero when the STA receives the PPDU with the valid MPDU that contains the RTS frame, and a transmitter address (TA) of the RTS frame is an address of an AP STA or non-AP STA affiliated with an MLD, which is not operating on an NSTR pair, or an address of an AP STA or non-AP STA which is not affiliated with an MLD.

6. The STA of claim 2, wherein in response to the STA being affiliated with an MLD, the STA resets the MediumSyncDelay timer to zero when the STA receives the PPDU with the valid MPDU that contains the RTS frame, and the RTS frame is sent by an AP affiliated with an NSTR soft AP MLD with which the STA is associated in the nonprimary link, and a time interval between the end time of a PPDU the most recently transmitted by the other AP affiliated with the same soft AP MLD in a primary link, which is detectable by the other STA affiliated with the same MLD as the STA, and the start of reception of the PPDU with the valid MPDU that contains the RTS frame is longer than or equal to MediumSyncDelay, which is the Medium Synchronization duration of the MediumSyncDelay timer, and the transmission event of the PPDU the most recently transmitted by the other AP affiliated with the same soft AP MLD is longer than aMediumSyncThreshold; and/or
in response to the STA being affiliated with an MLD, the STA does not reset the MediumSyncDelay timer to zero when the STA receives the PPDU with the valid MPDU that contains the RTS frame, and the RTS frame is sent by an AP affiliated with an NSTR soft AP MLD with which the STA is associated in the nonprimary link, and a time interval between the end time of a PPDU the most recently transmitted by the other AP affiliated with the same soft AP MLD in the primary link and the start of reception of the PPDU with the valid MPDU that contains the RTS frame is shorter than MediumSyncDelay and the transmission event of the PPDU the most recently transmitted by the other AP affiliated with the same soft AP MLD in the primary link is longer than aMediumSyncThreshold.

7. The STA of claim 2, wherein in response to the STA being affiliated with an MLD, the STA resets the MediumSyncDelay timer to zero when the STA receives the PPDU with the valid MPDU that contains the RTS frame, and the transmitter address (TA) of the RTS frame is an address of a TDLS peer STA affiliated with another MLD, which is not operating on an NSTR pair, or an address of a TDLS peer STA which is not affiliated with an MLD; or
in response to the STA being affiliated with an MLD, the STA resets the MediumSyncDelay timer to zero when the STA receives the PPDU with the valid MPDU that contains the RTS frame, and the RTS frame is sent from a TDLS peer STA affiliated with another MLD, which is not operating on an NSTR pair, or from a TDLS peer STA which is not affiliated with an MLD.

8. The STA of claim 2, wherein in response to the STA being affiliated with an MLD, the STA is affiliated with an NSTR soft AP MLD in a nonprimary link, has a nonzero MediumSyncDelay timer, and when capable of obtaining a TXOP the STA transmits an RTS frame as an initial frame of an obtained TXOP to its associated non-AP STA in the nonprimary link only if another STA affiliated with the same soft AP MLD in the primary link is also initiating another PPDU as a TXOP holder or another STA affiliated with the same soft AP MLD in the primary link is also transmitting another PPDU at the same time; or
wherein in response to the STA being affiliated with an MLD, the STA is affiliated with a non-AP MLD that is associated with an NSTR soft AP MLD, the STA is in a nonprimary link and has a nonzero MediumSyncDelay timer, and when capable of obtaining a TXOP the STA transmits an RTS frame as an initial frame of an obtained TXOP only if another STA affiliated with the same non-AP MLD in the primary link is also initiating another PPDU as a TXOP holder or another STA affiliated with the same non-AP MLD in the primary link is also transmitting another PPDU at the same time.

9. The STA of claim 2, wherein in response to the STA supporting an operation for a control frame including a medium access recovery field, the control frame including the medium access recovery subfield is a multi-user RTS (MU-RTS) trigger frame.

10. The STA of claim 9, wherein the medium access recovery subfield is located in the 28th bit B27 of the EHT variant Common Info field of the MU-RTS trigger frame;
the medium access recovery subfield is located in the 37th bit B36 of the EHT variant Common Info field of the MU-RTS trigger frame; or
the medium access recovery subfield is located in the 35th to 36th bits of the EHT variant Common Info field of the MU-RTS trigger frame.

11. The STA of claim 9, wherein a first value in the medium access recovery subfield indicates that the MU-RTS trigger frame is sent by the STA that has a nonzero MediumSyncDelay timer; and
a second value in the medium access recovery subfield indicates that the MU-RTS Trigger frame is sent by the STA that has a zero MediumSyncDelay timer, or does not have any MediumSyncDelay timer.

12. The STA of claim 11, wherein the STA is affiliated with an MLD, the STA has a nonzero MediumSyncDelay timer and supports to obtain a TXOP, and the STA transmits an MU-RTS Trigger frame in which a value of the medium access recovery subfield is the first value, as the first frame of any attempt to obtain a TXOP.

13. The STA of claim 11, wherein the STA is an STA affiliated with a multi-link device (MLD), the STA has a nonzero MediumSyncDelay timer and supports to obtain a TXOP; the STA doesn't reset the MediumSyncDelay timer to zero when the STA receives a PPDU with a valid MPDU that contains an MU-RTS Trigger frame in which a value of the medium access recovery subfield is the first value; and/or
the STA resets the MediumSyncDelay timer to zero when the STA receives a PPDU with a valid MPDU that contains an MU-RTS Trigger frame in which a value of the medium access recovery subfield is the second value.

14. The STA of claim 2, wherein in response to the STA supporting an operation for a control frame including a medium access recovery field, the control frame including the medium access recovery subfield is a request to send (RTS) frame.

15. The STA of claim 14, wherein the medium access recovery subfield is located in the 13th bit B12 of the Frame Control field of the RTS frame; or
the medium access recovery subfield is located in the 16th bit B15 of the Frame Control field of the RTS frame.

16. The STA of claim 14, wherein a first value in the medium access recovery subfield indicates that the RTS frame is sent by the STA that has a nonzero medium synchronization delay; and/or
a second value in the medium access recovery subfield indicates that the RTS frame is sent by the STA that has a zero MediumSyncDelay timer, or does not have any MediumSyncDelay timer.

17. The STA of claim 16, wherein the STA is affiliated with an MLD, the STA has a nonzero MediumSyncDelay timer and supports to obtain a TXOP, and the STA transmits an RTS frame in which a value of the medium access recovery subfield is the first value, as the first frame of any attempt to obtain a TXOP.

18. The STA of claim 16, wherein the STA is affiliated with an MLD, the STA has a nonzero MediumSyncDelay timer and supports to obtain a TXOP; the STA doesn't reset the MediumSyncDelay timer to zero when the STA receives a PPDU with a valid MPDU that contains an RTS frame in which a value of the medium access recovery subfield is the first value; and/or
the STA resets the MediumSyncDelay timer to zero when the STA receives a PPDU with a valid MPDU that contains an RTS frame in which a value of the medium access recovery subfield is the second value.

19. The STA of claim 2, wherein in response to the STA supporting an operation for a control frame including a medium access recovery field, the STA is affiliated with an NSTR soft AP MLD in a nonprimary link, has a nonzero MediumSyncDelay timer, and when capable of obtaining a TXOP the STA transmits an RTS frame as an initial frame of an obtained TXOP to its associated non-AP STA in the nonprimary link only if another STA affiliated with the same soft AP MLD in the primary link is also initiating another PPDU as a TXOP holder or another STA affiliated with the same soft AP MLD in the primary link is also transmitting another PPDU at the same time; or
wherein in response to the STA supporting an operation for a control frame including a medium access recovery field, the STA is affiliated with a non-AP MLD that is associated with an NSTR soft AP MLD, the STA is in a nonprimary link and has a nonzero MediumSyncDelay timer, and when capable of obtaining a TXOP the STA transmits an RTS frame as an initial frame of an obtained TXOP only if another STA affiliated with the same non-AP MLD in the primary link is also initiating another PPDU as a TXOP holder or another STA affiliated with the same non-AP MLD in the primary link is also transmitting another PPDU at the same time.

20. A computer readable storage medium, in which a computer program is stored, wherein the computer program causes a computer to execute a method, and the method comprises:
a wireless station (STA) affiliated with a multi-link device (MLD), which has a nonzero medium synchronization delay (MediumSyncDelay) timer, when receiving a physical protocol data unit (PPDU) with a valid media access control protocol data unit (MPDU) that contains a request to send (RTS) frame or a multi-user RTS (MU-RTS) trigger frame, determining whether to reset the MediumSyncDelay timer to zero according to detecting of the PPDU; or
a STA, that supports an operation for a control frame including a medium access recovery subfield, transmitting a control frame including a medium access recovery subfield indicating whether the control frame is sent by the STA that has a nonzero MediumSyncDelay timer if needed.
